(19) United States
(12) Patent Application Publication
(10) Pub. No.: US 2026/0178372 A1
(43) Pub. Date: Jun. 25, 2026

(54) SYSTEMS AND METHODS FOR AUTOMATED PROCESS HANDLING

(71) Applicants: Ananya ROY, Toronto (CA); Abdulrahman Allahham, Toronto (CA); Navid Fekri, Toronto (CA)

(72) Inventors: Ananya ROY, Toronto (CA); Abdulrahman Allahham, Toronto (CA); Navid Fekri, Toronto (CA)

(21) Appl. No.: 19/426,415

(22) Filed: Dec. 19, 2025

Related U.S. Application Data
(60) Provisional application No. 63/737,125, filed on Dec. 20, 2024.

(51) Int. Cl. G06F 9/48; G06F 9/54

(52) U.S. Cl. CPC G06F 9/4818; G06F 9/541

(57) ABSTRACT

Methods and systems are described for responding to a request in a computing system. The method comprises retrieving one or more hierarchical policies from a database of policies using the goal of the request, each hierarchical policy comprising one or more hierarchical tasks, retrieving one or more Application Program Interfaces associated with a goal of the request and identifying one or more target Application Program Interfaces required for accomplishment of the goal. The method also comprises forming a hierarchical queue of tasks and completing each task in the hierarchical queue of tasks before calling the one or more target Application Program Interfaces to accomplish the goal.

### CROSS-REFERENCE TO PREVIOUS APPLICATION

This application claims priority from U.S. provisional patent application 63/737,125 filed on Dec. 20, 2024, which is incorporated herein by reference in its entirety.

### FIELD

The present disclosure generally relates to the field of automated process handling. In particular, various embodiments are described herein that relate to systems and methods for automatically handling processes associated with incoming user requests.

### INTRODUCTION

The following paragraphs are provided by way of background to the present disclosure. They are not, however, an admission that anything discussed therein is prior art or part of the knowledge of persons skilled in the art.

Automating processes or components of a process at scale i.e., automating many processes at once, typically takes a very long time. For example, many organizations (such as businesses) have processes that are very manual, repetitive and need to be performed frequently. In accordance with the conventional paradigm of enterprise software development, the traditional approach of engagement between a business unit and technology teams for each use case is to have the business units engage with one or more technology teams for several months to build, deploy and operationalize a software system.

While this approach is well known to most organizations, it often results in disadvantages. For example, by using such a traditional approach, the cost of automating a business process can become very high, and because the engagement is inflexible, solutions to automation are not typically scalable.

Because technology teams are the solution providers and the business teams are the users, for every change, the business needs to engage the technology teams. As a result, the relationships and flows of information between the technology teams and the business teams can create critical bottlenecks that further exacerbate slow development.

There is a need for systems and methods for automatically handling processes associated with incoming user requests that address the challenges and/or shortcomings described above.

### SUMMARY

Various embodiments of systems and methods for automatically handling processes associated with incoming user requests are provided according to the teachings herein.

According to an aspect of the present disclosure, there is provided a method of responding to a request in a computing system. The method comprises analyzing the request to determine a goal of the request and retrieving one or more hierarchical policies from a database of policies using the goal, each hierarchical policy comprising one or more hierarchical tasks. The method also comprises retrieving one or more Application Program Interfaces associated with the goal from an Application Program Interface database, thereby forming a group of available Application Program Interfaces, and identifying one or more target Application Program Interfaces required for accomplishment of the goal. The method also comprises forming a hierarchical queue of tasks using the one or more hierarchical tasks, completing each task in the hierarchical queue of tasks, and calling the one or more target Application Program Interfaces to accomplish the goal.

In some examples, the step of completing each task in the hierarchical queue of tasks comprises repeating the following until each task in the hierarchical queue of tasks is completed: generating an action associated with the next task in the hierarchical queue of tasks using any contents of a store of gathered information, wherein the action is associated with the completion of the next task if the information required to complete the next task can be found in the request or the store of gathered information, or the action is associated with finding information required for the completion of the next task if the information required to complete the next task cannot be found in the request or the store of gathered information; executing the action using the contents of the store of gathered information and storing a result of the action in the store of gathered information; and updating the hierarchical queue of tasks to remove any completed task and add any new tasks.

In some examples, if the action is associated with finding information required for the completion of the next task, the action relates to finding a new Application Program Interface from among the group of available Application Program Interfaces that can be used to retrieve the information required for the completion of the next task, and the result of the action is the generation of a new task requiring the calling of the new Application Program Interface.

According to another aspect of the present disclosure, there is provided a non-transitory computer-readable storage medium storing a plurality of instructions executable by one or more processors, the plurality of instructions when executed by the one or more processors cause the one or more processors to execute the above method.

According to yet another aspect of the present disclosure, there is provided system for responding to a request in a computing system. The system comprises an agent initializer configured to analyze the request to determine a goal of the request; retrieve one or more hierarchical policies from a database of policies using the goal, each hierarchical policy comprising one or more hierarchical tasks; retrieve one or more Application Program Interfaces associated with the goal from an Application Program Interface database, thereby forming a group of available Application Program Interfaces; identify one or more target Application Program Interfaces required for accomplishment of the goal; and form a hierarchical queue of tasks using the one or more hierarchical tasks. The system also comprises a cognitive updater, an action generator and an execution agent configured to complete each task in the hierarchical queue of task and call the one or more target Application Program Interfaces to accomplish the goal.

In some examples, the action generator is further configured to generate an action associated with the next task in the hierarchical queue of tasks using any contents of a store of gathered information, wherein the action is associated with the completion of the next task if the information required to complete the next task can be found in the request or the store of gathered information, or the action is associated with finding information required for the completion of the next task if the information required to complete the next task cannot be found in the request or the store of gathered information. The execution agent is further configured to execute the action using the contents of the store of gathered information and storing a result of the action in the store of gathered information. The cognitive updater is further configured to update the hierarchical queue of tasks to remove any completed task and add any new tasks.

In some examples, if the action is associated with finding information required for the completion of the next task, the action relates to finding a new Application Program Interface from among the group of available Application Program Interfaces that can be used to retrieve the information required for the completion of the next task, and the result of the action is the generation of a new task requiring the calling of the new Application Program Interface.

In some examples, the request is received via email or chat from a requester.

In some examples, the system is further configured to query the requester and to receive one or more requester responses containing response information, and wherein the action generator is further configured to generate an action based on the response information and the execution agent is further configured to execute the action based on the response information.

In some examples, the action is one of CHECK CONDITION, which comprises checking whether a condition is met or not, MAP CONDITION which comprises mapping the condition to either an Application Programming Interface to find information about a condition or querying the requester for more information, MAP ACTION, which comprise mapping an action to one of the available Application Programming Interfaces, CALL API, which comprise executing an Application Programming Interface with a found parameters, or FIND PARAM, which comprises finding a parameter for a mapped Application Programming Interface.

Other features and advantages of the present disclosure will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein. In the drawings:

FIG. 1 shows a simplified schematic diagram of a computer network suitable for implementing embodiments of the present disclosure;

FIG. 2 shows a simplified schematic diagram of a computing device suitable for implementing embodiments of the present disclosure;

FIG. 3 shows a simplified schematic diagram of functional software modules in accordance with embodiments of the present disclosure; and

FIG. 4 shows a simplified block diagram of methods in accordance with embodiments of the present disclosure.

Further aspects and features of the example embodiments described herein will appear from the following description taken together with the accompanying drawings.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to systems or methods having all of the features of any one of the systems or methods described below or to features common to multiple or all of the systems or methods described herein. It is possible that there may be a system or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

The example embodiments of the systems or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including one or more of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level programming language. The program code may be written in Rust, C++, C#, JavaScript, Python, or any other suitable programming language and may comprise modules or classes, as is known to those skilled in the art. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, solid-state storage, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the systems and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

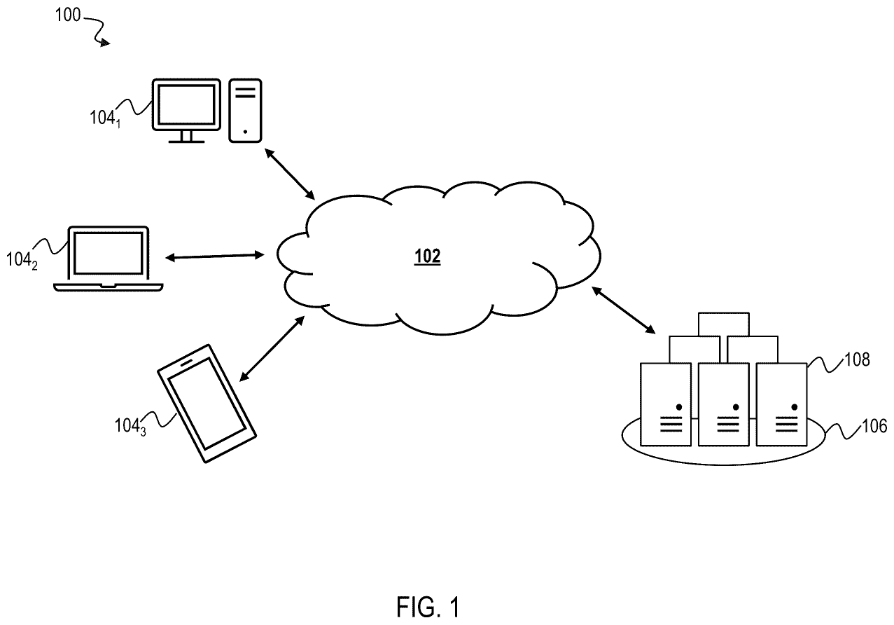

Referring now to FIG. 1, there is shown a computer network 100 that comprises an example embodiment of a system implementing the systems and methods described herein. More particularly, the computer network 100 comprises a wide area network 102 such as the Internet to which various computing devices 104ₓ, and cloud computing service 106 are communicatively coupled. The cloud computing service 106 may comprise a number of computing devices 108 networked together to collectively perform various computing functions. For example, in the context of machine learning, the cloud computing service 106 may host machine learning models, such as those described herein, and associated functionality.

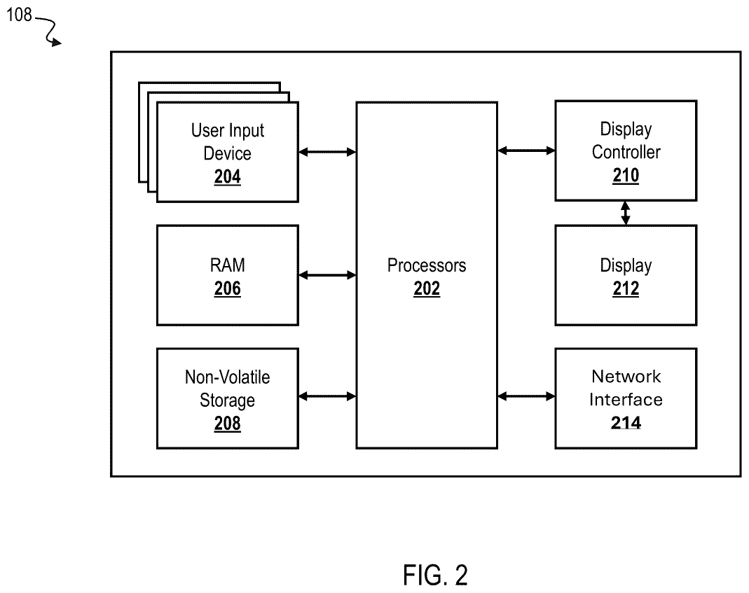

Referring now to FIG. 2, there is depicted an example embodiment of one of the computing devices 108 that comprises the cloud computing service 106. The computing device 108 comprises processors 202 that control the computing device's 108 overall operation. The processors 202 are communicatively coupled to and controls several subsystems. Processors 202 may include one or more graphical processing unit (GPU). The GPU may be used for computational purposes as an adjunct to, or instead of, a central processing unit (CPU), for mathematical calculations.

These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other computing devices 108 in the data center 106.

The non-volatile storage 208 has stored on it computer program code that is loaded into the RAM 206 at runtime and that is executable by processors 202. When the computer program code is executed by the processors 202, the processors 202 cause the computing device 108 to implement methods such as those described herein. Additionally, or alternatively, the computing devices 108 may collectively perform the method described herein using distributed computing. While the system depicted in FIG. 2 is described specifically with respect to one or more of the computing devices 108, analogous versions of the system may also be used within computing devices 104ₓ.

The term “computing device” and related terms, as used herein, is not limited to any particular type of computer system and encompasses servers, desktop computers, laptop computers, networked mobile wireless telecommunication computing devices such as smartphones, tablet computers, as well as other types of computer systems.

In accordance with the teachings herein, there are provided various embodiments for a generative Artificial Intelligence (AI) planning and execution agent capable of interpreting various business process descriptions, converting them into discrete actions, planning the execution sequence of the discrete actions and executing the actions in the planning sequence. This agent enables processes or workflow automation at scale and has the potential to be applied to a wide variety of applications across different organizations.

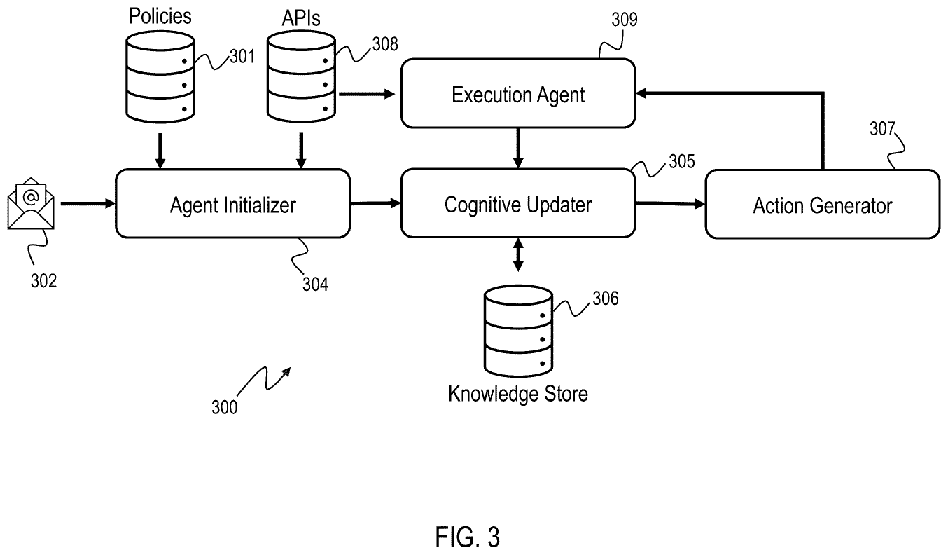

FIG. 3 shows a simplified schematic diagram of functional software modules of generative AI planning and execution agent 300 in accordance with embodiments of the present disclosure. The generative AI planning and execution agent 300 comprises a planning agent and an execution agent.

The planning agent comprises a knowledge store 306, which includes a number of subcomponents used in storing different types of knowledge. In some embodiments, knowledge store 306 may contain a plan, actions, policies, parameter memory, and short-term memory, as described in more detail elsewhere herein.

As used herein, a plan is a core component that represents a prioritized list of tasks to be executed at a certain moment. The plan may dynamically change as the generative AI planning and execution agent 300 progresses through a plan by finding information required to accomplish tasks and then accomplishing such tasks.

As used herein, actions are executable steps that can be executed by the execution agent, and may include, for example, available Application Program Interfaces (APIs) or executable actions such as asking a question. Actions included, but are not limited to, CHECK CONDITION (i.e., the agent checks to see whether a condition is met or not), MAP CONDITION (i.e., if the condition is not met, the agent attempts to map the condition to either an API to find information about that condition or asks the user/requester for more information), MAP ACTION (i.e., map an action to the available APIs), CALL API (i.e., executes an API with the found parameters), FIND PARAM (i.e., find the parameters for the mapped API).

As used herein, policies are pieces of information that contain the procedures that generative AI planning and execution agent 300 must follow to fulfill a request. Parameter memory is a structured part of the knowledge store that stores parameter values as these become known during the course of fulfilling a request, as described in more detail herein.

As used herein, short-term memory is an unstructured part of the memory suitable for storing the results of calls to Large Language Models (LLMs), as well as answers by human and non-human resources to questions posed by the execution agent and calls made be the execution agent, respectively. Short term memory is one of the sources used by the generative AI planning and execution agent 300 for inferring values of unknown parameters. As used herein, short term memory may be used for storing information related to user/requester interactions and responses that dictate next steps. For example, in the example disclosed in more detail elsewhere herein, the short term memory may be used to store answers from a user/requester, when the system is asked whether they want to transfer their reward points to another card.

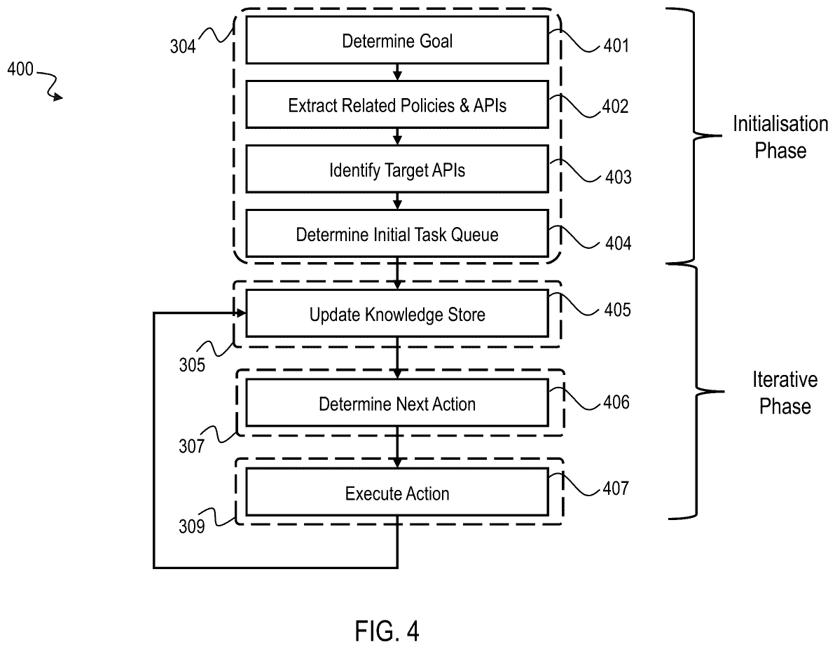

The planning agent also comprises the agent initializer 304, which carries out initialization phase, as shown in (and described with respect to) FIG. 4.

The planning agent also comprises a cognitive updater 305, which represents the central component of the planning agent. The cognitive updater 305 updates the knowledge store plan in light of the most recent action executed by execution agent 309. The cognitive updater 305 updates the plan by deciding what to do next given the current state of the knowledge store 306, as described in more detail elsewhere herein.

The planning agent also comprises an action generator 307 which converts the highest priority tasks in a plan to a description of an action to be executed. Finally, the execution agent 309 is responsible for executing the action generated by the planning agent.

The following non-limiting example will be used to illustrate the features, operation and advantages of the presently disclosure systems and methods. As will be appreciated by the skilled reader, however, this non-limiting illustrative example is used to elucidate the structure and operation of the systems and methods described herein, which systems and methods could be applied to a variety of other applications in a variety of other use cases.

The illustrative example used herein will be that of a financial institution receiving an email request from a customer asking that their credit card be cancelled. The email may, for example, read: “Hi I hope you are doing well My name is John Doe and I would like to cancel my credit card. Thanks”. The execution agent of the following example may be powered by any suitable LLM, including, but not limited to, a Falcon40B model.

The receipt of request 302 triggers the generative AI planning and execution agent 300 to start the method of FIG. 4. Request 302 may be received via email, via chat, or via any other suitable means. At step 401, the agent initializer 304 determines the goal from the email. This can be done using known methods of prompting the LLM to extract the goal or intent of email request 302. For example, the prompt could be something like “extract the main goal from the following text using the goal extraction example below. [Example of text and goal extracted] [Input Text—from where we want to extract the goal] Output:”.

In the illustrative example, the determined goal is “cancel credit card”. Next, at step 402, the agent initializer 304 extracts the business policies and processes that must be satisfied to fulfil the request relevant to the goal determined in the request. In some embodiments, the business policies may be found and subsequently extracted from a business policy database 301 using the goal (or part of the goal) as a search term. In the illustrative example, the policies extracted are:
Policy 1: if the credit card type is X, ask the client if they want to transfer the cash back; if the client confirms to receive cash back, ask the client for an account number; if the account number if confirmed, transfer the case back amount to the account,
Policy 2: if the credit card is expired, inform the client that the credit card cannot be cancelled,
Policy 3: if the client has reward points, ask the client if they want to transfer them to another card; if the client confirms the transfer of the reward points to another card, ask for the card number and the name of the recipient; if the card number and the name o the recipient are confirmed, transfer the reward points.

Next, at step 402, the agent initializer 304 of the planning agent uses the determined goal to extract a number of APIs available that can be called to fulfill the request. As defined herein, the extracted APIs become a set of available APIs that can be called to proceed toward ultimate fulfillment of the request. In some embodiments, the set of available APIs may be extracted from an API database 308. In the illustrative example, the set of available APIs associated to “cancel credit card” are shown in Table 1, below:

TABLE 1
Available APIs associated with “Cancel Credit Card”

‘CREDIT_CARD_INFO’: {‘description’: “This API gets the client's name and find the credit number.”,
‘arguments': ‘client name’, ‘output’: ‘client credit number),
‘CREDIT_CARD_CANCEL’: {‘description’: “This API gets the client's credit number and cancel the credit
card.”, ‘arguments': ‘client credit number’, ‘output’: ‘success or fail),
‘CREDIT_CARD_EXPIRED’: {‘description’: “This API gets the client's credit number and check if the credit
card is expired.”, ‘arguments': ‘client credit number’, ‘output’: ‘success or fail’},
‘CREDIT_CARD_X’: {‘description’: “This API gets the client's credit number and check if the card type is X.”,
‘arguments’: ‘client credit number’, ‘output’: ‘success or fail),
‘GET_REWARD_POINT’: {‘description’: This API checks if the client has reward points.’, ‘arguments’: ‘client
credit number’, ‘output’: ‘success or fail),
‘TRANSFER_REWARD_POINT’: {‘description’: This API transfers the reward points from the client to the
recipient.’, ‘arguments’: “client credit number, recipient's credit number”, ‘output’: ‘success or fail’)

Then, at step 403, the agent initializer 304 of the planning agent identifies a target API from among the set of available APIs that can be used to ultimately fulfill the request. In the illustrative example, ultimate fulfillment of the request can be accomplished by way of a single API. In other examples, however, it will be appreciated that ultimate fulfillment of the request may be accomplished by way of two or more APIs. In the illustrative example, the target API is determined as being “CREDIT_CARD_CANCEL”.

In some embodiments, this can be accomplished by using all the API information as a search space (i.e., can be embedded in a vector database) and then running a query to match the goal/intent with the API vector embeddings to get the closest match of the target API. The available APIs can first be vectorized in a vector database such as chroma DB™. Then once extracted from the request, the goal/intent of the message may also be vectorized and compared against the embedded/vectorized API data to find the closest match between “credit card cancellation” and the available API's.

Finally, at step 404, the agent initializer 304 creates an initial task queue, which comprises a sequential list of tasks (e.g., Task0 to TaskX), in which the last task (e.g., Task0) is determined using the target API and the other tasks (e.g., Task1 to TaskX) are determined using the extracted policies.

Once the planning agent is initialized by agent initializer 304, it has the goal it needs to execute, as well as the basic context and/or information that is needs to fulfill the request. At this point, as shown in FIG. 4, the generative AI planning and execution agent 300 then enters into an iterative process in which it dynamically uses the information it has to create/update a plan, generate an action, execute the action, create/update the plan, generate an action, etc.

The iterative stage of the method of FIG. 4 is where the generative AI planning and execution agent 300 iterates over the three critical components of the planner agent, namely the cognitive updater, the knowledge store and the action generator, as follows.

First, at step 405, the cognitive updater 305 updates the knowledge store 306 by updating the plan, the information gathered by the agent so far in the iterative process, as well as the short-term memory. Once the knowledge store is updated, at step 406, the action generator 307 translates the highest priority task in the plan to determine the next action. In other words, the action generator determines the next action to take based on the knowledge store. Finally, at step 407, the action generated by the action generator 307 at step 406 is executed by the execution agent 309.

In Table 2, the generative AI planning and execution agent 300 of the illustrative example begins with the information resulting from the initialization of the agent and generates a basic plan in the knowledge store. The plan consists of several tasks. In the example of Table 2, there are four tasks ranked in order of their priority of execution. The tasks are thus in the form of a queue.

Each task may have a “type” of action (e.g., calling an API or checking for a condition), a “value” and “parameters”. The last task is calling an API which is the target API identified during initialization of the agent. The next three tasks come from the business policies extracted during initialization of the agent, and relate to the business processes that need to be met before the target task can be completed by way of calling the API “CREDIT_CARD_CANCEL”. Task3 has the highest priority and has to be executed first and will be translated into an action by action generator 307.

TABLE 2
Knowledge Store:
Plan:
Task0: (type’: ‘api’, ‘value’: ‘CREDIT_CARD CANCEL’, ‘parameters’: ‘client credit number’}
Task1: {‘type’: ‘condition’, ‘value’: ‘If the credit card type is X’}
Task2: {‘type’: ‘condition’, ‘value’: ‘If the credit card is expired’}
Task3: {‘type’: ‘condition’, ‘value’: ‘If the client has reward points’}
Information Gathered:
Short Term Memory:

Once the knowledge store is updated at step 405, the next step in the method is for the action generator 307 to generate the next action based on the highest priority task in light of what is known in the updated knowledge store 306. As shown in Table 2, the highest priority task is Task3, and the task type is a “condition” type (i.e., check condition), and the value of the condition is “if the client has reward points”. Thus, at step 406, action generator 307 creates the action “Check Condition” with a value of “if the client has reward points”.

The next step is for the execution agent 309 to execute the action at step 407. This is done by a call to LLM using the information that generative AI planning and execution agent 300 has so far (i.e., the “Information Gathered” and “Short Term Memory” in Table 2, as well as any information in the request itself) to execute the previous condition of checking for the condition. In the illustrative example, because the generative AI planning and execution agent 300 does not have all the information to proceed to check the condition, the answer from LLM is “I don't know”.

Next, generative AI planning and execution agent 300 updates the knowledge store 306 at step 405 using cognitive updater 305, resulting in the knowledge store 306 containing the information shown in Table 3.

TABLE 3
Knowledge Store:
Plan:
Task0: (type’: ‘api’, ‘value’: ‘CREDIT_CARD CANCEL’, ‘parameters’: ‘client credit number’}
Task1: {‘type’: ‘condition’, ‘value’: ‘If the credit card type is X’}
Task2: {‘type’: ‘condition’, ‘value’: ‘If the credit card is expired’}
Task3: {‘type’: ‘condition’, ‘value’: ‘If the client has reward points’}
Task4: {‘type’: ‘map’, ‘value’: ‘If the client has reward points’}
Information Gathered:
Short Term Memory:

As shown in Table 3, as a result of the LLM returning the answer “I don't know” (i.e., the AI planning and execution agent 300 does not have the information required to check the condition), the AI planning and execution agent 300 adds a new task in the plan. The task type for Task4 is “map”, which indicates that it is aimed at finding the relevant information so the condition can eventually be checked. Task4 now becomes the highest priority task in the plan.

Once the knowledge store is updated at step 405, the next step in the method is for the action generator 307 to generate the next action based on the highest priority task in light of what is known in the updated knowledge store 306. As shown in Table 3, the highest priority task is Task4, and the task type is a “map” type (i.e., find information), and the value of the condition is “if the client has reward points”. Thus, at step 406, the action generator 307 creates the action “map” having a value of “if the client has reward points”.

The next step is for the execution agent 309 to execute the action at step 407. This, again, is done by a call to LLM using the information that generative AI planning and execution agent 300 has so far (i.e., the “Information Gathered” and “Short Term Memory” in Table 3, as well as any information in the request itself) to execute the previous condition of map for the condition. In this case, the response is an API called “GET_REWARD_POINT”, which fetches the reward points of a client. In some embodiments, this can be accomplished by vectorizing “if the client has reward points” and comparing it with the vectorized available APIs, as described in more detail elsewhere herein.

Next, generative AI planning and execution agent 300 updates the knowledge store at step 405 using cognitive updater 305, resulting in the knowledge store 306 containing the information shown in Table 4.

TABLE 4
Knowledge Store:
Plan:
Task0: (type’: ‘api’, ‘value’: ‘CREDIT_CARD CANCEL’, ‘parameters’: ‘client credit number’}
Task1: {‘type’: ‘condition’, ‘value’: ‘If the credit card type is X’}
Task2: {‘type’: ‘condition’, ‘value’: ‘If the credit card is expired’}
Task3: {‘type’: ‘condition’, ‘value’: ‘If the client has reward points’}
Task4: {‘type’: ‘map’, ‘value’: ‘If the client has reward points’}
Task5: {‘type’: ‘api’, ‘value’: ‘GET_REWARD_POINT’, ‘parameters’: ‘client credit number’, ‘is_rule_related’:
True}
Information Gathered:
Short Term Memory:

As shown in Table 4, because the LLM returned the answer “GET_REWARD_POINT”, the AI planning and execution agent 300 adds a new task in the plan, namely Task5. The task type for Task5 is “api”, which indicates that it is aimed at calling an API called “GET_REWARD_POINT”. Task5 now becomes the highest priority task in the plan.

Once the knowledge store is updated at step 405, the next step in the method is for the action generator 307 to generate the next action based on the highest priority task in light of what is known in updated knowledge store 306. As shown in Table 4, the highest priority task is Task5, and the task type is a “api” type (i.e., call api). As the parameter for calling the API is not found in “Information Gathered” (see Table 4), the action generator 307 updates the action to “FIND PARAM”, meaning that it must now find the parameter for the GET_REWARD_POINT API, which parameter is the client credit card number.

The next step is for the execution agent 309 to execute the action at step 407. This, again, is done by a call to LLM using the information that generative AI planning and execution agent 300 has so far (i.e., the “Information Gathered” and “Short Term Memory” in Table 4, as well as any information in the request itself) to execute the find parameter action for the “client credit number”, as shown in Table 4. The result of this action is to call another API, namely CREDIT_CARD_INFO, which provides credit card related information. Here, the action has been determined by searching the available APIs associated with “Cancel Credit Card”. In some embodiments, this can be accomplished by vectorizing “credit card number” and comparing it with the vectorized available APIs, as described in more detail elsewhere herein.

Next, generative AI planning and execution agent 300 updates the knowledge store 306 at step 405 using cognitive updater 305, resulting in the knowledge store 306 containing the information shown in Table 5.

TABLE 5
Knowledge Store:
Plan:
Task0: (type’: ‘api’, ‘value’: ‘CREDIT_CARD CANCEL’, ‘parameters’: ‘client credit number’}
Task1: {‘type’: ‘condition’, ‘value’: ‘If the credit card type is X’}
Task2: {‘type’: ‘condition’, ‘value’: ‘If the credit card is expired’}
Task3: {‘type’: ‘condition’, ‘value’: ‘If the client has reward points’}
Task4: {‘type’: ‘map’, ‘value’: ‘If the client has reward points’}
Task5: {‘type’: ‘api’, ‘value’: ‘GET_REWARD_POINT’, ‘parameters’: ‘client credit number’, ‘is_rule_related’:
True}
Task6: {‘type’: ‘api’, ‘value’: ‘CREDIT_CARD_INFO’, ‘parameters’: ‘client name’}
Information Gathered:
Short Term Memory:

As shown in Table 5, because the LLM returned the answer “CREDIT_CARD_INFO”, the AI planning and execution agent 300 adds a new task in the plan, namely Task6. The task type for Task6 is “api”, which indicates that it is aimed at calling an API called “CREDIT_CARD_INFO”. Task6 now becomes the highest priority task in the plan.

Once the knowledge store is updated at step 405, the next step in the method is for the action generator 307 to generate the next action based on the highest priority task in light of what is known in the updated knowledge store. As shown in Table 5, the highest priority task is Task6, and the task type is a “api” type (i.e., call api).

As the parameter for calling the API is not found in “Information Gathered” (see Table 5), the action generator 307 updates the action to “FIND PARAM”, meaning that it must now find the parameter for the CREDIT_CARD_INFO API, which parameter is the client name.

The next step is for the execution agent 309 to execute the action at step 407. This, again, is done by a call to LLM using the information that generative AI planning and execution agent 300 has so far (i.e., the “Information Gathered” and “Short Term Memory” in Table 5, as well as any information in the request itself) to execute the previous find parameter action for the “client name”, as shown in Table 5. The result of this action is “john doe”, which the LLM has found in email request 302.

Next, generative AI planning and execution agent 300 updates knowledge store 306 at step 405 using cognitive updater 305, resulting in knowledge store 306 containing the information shown in Table 6. This time the plan is not updated but the “Information Gathered” section is updated based on the output of the action in the last step. Hence the parameter client name: “john doe” is a new piece of information learned from executing the last action.

TABLE 6
Knowledge Store:
Plan:
Task0: (type’: ‘api’, ‘value’: ‘CREDIT_CARD CANCEL’, ‘parameters’: ‘client credit number’}
Task1: {‘type’: ‘condition’, ‘value’: ‘If the credit card type is X’}
Task2: {‘type’: ‘condition’, ‘value’: ‘If the credit card is expired’}
Task3: {‘type’: ‘condition’, ‘value’: ‘If the client has reward points’}
Task4: {‘type’: ‘map’, ‘value’: ‘If the client has reward points’}
Task5: {‘type’: ‘api’, ‘value’: ‘GET_REWARD_POINT’, ‘parameters’: ‘client credit number’, ‘is_rule_related’:
True}
Task6: {‘type’: ‘api’, ‘value’: ‘CREDIT_CARD_INFO’, ‘parameters’: ‘client name’}
Information Gathered:
Client name: john doe
Short Term Memory:

Once the knowledge store is updated at step 405, the next step in the method is for the action generator 307 to generate the next action based on the highest priority task and in light of what is known in the updated knowledge store 306. As shown in Table 6, the highest priority task is Task6, and the task type is a “api” type (i.e., call api). AI planning and execution agent 300 then uses the “Information Gathered” and the information found in request 302 and is able to generate an action to call the CREDIT_CARD_INFO API with the parameter {‘client name’:‘john doe’}, at step 406.

The next step is for the execution agent 309 to execute the action at step 407. Execution agent 309 now has all the necessary information to call API CREDIT_CARD_INFO using parameter {‘client name’:‘john doe’}, which results in the response {‘client credit number’:‘1111 2222 3333 4444’}.

Next, generative AI planning and execution agent 300 updates the knowledge store at step 405 using cognitive updater 305, resulting in the knowledge store 306 containing the information shown in Table 7. Another iteration of the iteration phase is thus completed.

Generative AI planning and execution agent 300 now has some main pieces of information like client name and client credit card number that are needed to complete some of the previous, uncompleted, tasks, as shown below. A this point (Step 405), the plan also gets updated and the previous task of calling the CREDIT_CARD_INFO API (Task6) is removed from the queue since it has been completed and the output of that task is added to “Information Gathered” in knowledge store 306.

TABLE 7
Knowledge Store:
Plan:
Task0: (type’: ‘api’, ‘value’: ‘CREDIT_CARD CANCEL’, ‘parameters’: ‘client credit number’}
Task1: {‘type’: ‘condition’, ‘value’: ‘If the credit card type is X’}
Task2: {‘type’: ‘condition’, ‘value’: ‘If the credit card is expired’}
Task3: {‘type’: ‘condition’, ‘value’: ‘If the client has reward points’}
Task4: {‘type’: ‘map’, ‘value’: ‘If the client has reward points’}
Task5: {‘type’: ‘api’, ‘value’: ‘GET_REWARD_POINT’, ‘parameters’: ‘client credit number’, ‘is_rule_related’:
True}
Information Gathered:
Client name: john doe
Client credit number: 1111 2222 3333 4444
Short Term Memory:

Once the knowledge store 306 is updated at step 405, the next step in the method is for the action generator 307 to generate the next action based on the highest priority task and in light of what is known in the updated knowledge store. As shown in Table 7, the highest priority task is now Task5, and the task type is a “api” type (i.e., call api). AI planning and execution agent 300 then uses the “Information Gathered” and the information found in request 302 and is thus able to create an action which is to call the GET_REWARD_POINT API with the parameter {‘client credit number’: ‘1111 2222 3333 4444’}.

The next step is for the execution agent 309 to execute the action at step 407. Execution agent 309 now has all the necessary information to call GET_REWARD_POINT API using parameter {‘client credit number’: ‘1111 2222 3333 4444’}, which results in the response {‘client reward point’:4000}.

Next, generative AI planning and execution agent 300 updates knowledge store 306 at step 404 using cognitive updater 305, resulting in knowledge store 306 containing the information shown in Table 8. The plan also gets updated and the previous task of calling the GET_REWARD_POINT API (Task5) is removed from the queue since it has been completed and the output of that task is added to the “Information Gathered” section in knowledge store 306.

TABLE 8
Knowledge Store:
Plan:
Task0: (type’: ‘api’, ‘value’: ‘CREDIT_CARD CANCEL’, ‘parameters’: ‘client credit number’}
Task1: {‘type’: ‘condition’, ‘value’: ‘If the credit card type is X’}
Task2: {‘type’: ‘condition’, ‘value’: ‘If the credit card is expired’}
Task3: {‘type’: ‘condition’, ‘value’: ‘If the client has reward points’}
Task4: {‘type’: ‘map’, ‘value’: ‘If the client has reward points’}
Information Gathered:
Client name: john doe
Client credit number: 1111 2222 3333 4444
Client reward point: 4000
Short Term Memory:

Once the knowledge store is again updated at step 405, the next step in the method is for the action generator 307 to generate the next action based on the highest priority task and in light of what is known in the updated knowledge store 306. As shown in Table 8, the highest priority task is Task4, and the task type is a “map” type (i.e., find information), and the value of the condition is “if the client has reward points”. Thus, the action determined at step 406 is “map” and the value is “if the client has reward points”.

The next step is for the execution agent 309 to execute the action at step 407. This, again, is done by a call to LLM using the information that generative AI planning and execution agent 300 has so far (i.e., the “Information Gathered” and “Short Term Memory” in Table 8, as well as any information in the request itself) to execute the previous condition of map for the condition. In this case, the result is “yes”, as the client reward point information is found in the “Information Gathered” section of knowledge store 306.

Thus, generative AI planning and execution agent 300 continues the iterative phase of the method shown in FIG. 4 until the goal is achieved. In this case, the goal is calling the “CREDIT_CARD CANCEL”, having found all the necessary information to successfully call the API, and having previously followed all of the policies associated with the goal “cancel credit card”.

As can be seen from the above description, the integration of LLMs and RAGs with automated customer/client request handling processes as described herein represent significantly more than merely using categories to organize, store and transmit information and organizing information through mathematical correlations. The integration of LLMs and RAGs with automated customer/client request handling processes is in fact an improvement to the technology of machine learning.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A method of responding to a request in a computing system, the method comprising:
analyzing the request to determine a goal of the request;
retrieving one or more hierarchical policies from a database of policies using the goal, each hierarchical policy comprising one or more hierarchical tasks;
retrieving one or more Application Program Interfaces associated with the goal from an Application Program Interface database, thereby forming a group of available Application Program Interfaces;
identifying one or more target Application Program Interfaces required for accomplishment of the goal;
forming a hierarchical queue of tasks using the one or more hierarchical tasks;
completing each task in the hierarchical queue of tasks; and
calling the one or more target Application Program Interfaces to accomplish the goal.

2. The method of claim 1, wherein the step of completing each task in the hierarchical queue of tasks comprises repeating the following until each task in the hierarchical queue of tasks is completed:
generating an action associated with the next task in the hierarchical queue of tasks using any contents of a store of gathered information, wherein:
the action is associated with the completion of the next task if the information required to complete the next task can be found in the request or the store of gathered information, or
the action is associated with finding information required for the completion of the next task if the information required to complete the next task cannot be found in the request or the store of gathered information;
executing the action using the contents of the store of gathered information and storing a result of the action in the store of gathered information;
updating the hierarchical queue of tasks to remove any completed task and add any new tasks.

3. The method of claim 2, wherein if the action is associated with finding information required for the completion of the next task, the action relates to finding a new Application Program Interface from among the group of available Application Program Interfaces that can be used to retrieve the information required for the completion of the next task, and the result of the action is the generation of a new task requiring the calling of the new Application Program Interface.

4. The method of claim 1, wherein the request is received via email or chat from a requester.

5. The method of claim 4, wherein the method further includes querying the requester and receiving one or more requester responses containing response information, and wherein generating an action and executing the action are also based on the response information.

6. The method of claim 1, wherein the action is one of CHECK CONDITION, which comprises checking whether a condition is met or not, MAP CONDITION which comprises mapping the condition to either an Application Programming Interface to find information about a condition or querying the requester for more information, MAP ACTION, which comprise mapping an action to one of the available Application Programming Interfaces, CALL API, which comprise executing an Application Programming Interface with a found parameters, or FIND PARAM, which comprises finding a parameter for a mapped Application Programming Interface.

7. A non-transitory computer-readable storage medium storing a plurality of instructions executable by one or more processors, the plurality of instructions when executed by the one or more processors cause the one or more processors to execute the method of claim 1.

8. A system for responding to a request in a computing system, the system comprising:
an agent initializer configured to:
analyze the request to determine a goal of the request;
retrieve one or more hierarchical policies from a database of policies using the goal, each hierarchical policy comprising one or more hierarchical tasks;
retrieve one or more Application Program Interfaces associated with the goal from an Application Program Interface database, thereby forming a group of available Application Program Interfaces;
identify one or more target Application Program Interfaces required for accomplishment of the goal; and
form a hierarchical queue of tasks using the one or more hierarchical tasks; and
a cognitive updater, an action generator and an execution agent configured to:
complete each task in the hierarchical queue of tasks; and
call the one or more target Application Program Interfaces to accomplish the goal.

9. The system of claim 8, wherein the action generator is further configured to:
generate an action associated with the next task in the hierarchical queue of tasks using any contents of a store of gathered information, wherein:
the action is associated with the completion of the next task if the information required to complete the next task can be found in the request or the store of gathered information, or
the action is associated with finding information required for the completion of the next task if the information required to complete the next task cannot be found in the request or the store of gathered information, and
the execution agent is further configured to:
execute the action using the contents of the store of gathered information and storing a result of the action in the store of gathered information, and
the cognitive updater is further configured to:
update the hierarchical queue of tasks to remove any completed task and add any new tasks.

10. The system of claim 9, wherein if the action is associated with finding information required for the completion of the next task, the action relates to finding a new Application Program Interface from among the group of available Application Program Interfaces that can be used to retrieve the information required for the completion of the next task, and the result of the action is the generation of a new task requiring the calling of the new Application Program Interface.

11. The system of claim 8, wherein the request is received via email or chat from a requester.

12. The system of claim 11, wherein the system is further configured to query the requester and to receive one or more requester responses containing response information, and wherein the action generator is further configured to generate an action based on the response information and the execution agent is further configured to execute the action based on the response information.

13. The system of claim 8, wherein the action is one of CHECK CONDITION, which comprises checking whether a condition is met or not, MAP CONDITION which comprises mapping the condition to either an Application Programming Interface to find information about a condition or querying the requester for more information, MAP ACTION, which comprise mapping an action to one of the available Application Programming Interfaces, CALL API, which comprise executing an Application Programming Interface with a found parameters, or FIND PARAM, which comprises finding a parameter for a mapped Application Programming Interface.
